(19) United States
(12) Patent Application Publication
(10) Pub. No.: US 2010/0031147 A1
(43) Pub. Date: Feb. 4, 2010

(54) METHOD AND SYSTEM FOR MIXING OF MULTIMEDIA CONTENT

(75) Inventors: Carnet Williams, Honolulu, HI (US); Kevin Hughes, Honolulu, HI (US); Matthew McNeely, Epping, NH (US)

Correspondence Address: VIRTUAL LAW PARTNERS LLP, P.O. BOX 1329, MOUNTAIN VIEW, CA, 94042, US

(73) Assignee: Chipln Inc., Honolulu, HI (US)

(21) Appl. No.: 12/511,728

(22) Filed: Jul. 29, 2009

Related U.S. Application Data
(60) Provisional application No. 61/085,231, filed on Jul. 31, 2008.

(51) Int. Cl. G06F 3/00; G06F 3/048; G06F 15/16

(52) U.S. Cl. 715/716; 715/762; 715/764; 709/203

(57) ABSTRACT

Computer-implemented methods and systems for providing a copy of a widget for a user are described. The widget is copyable, for dynamically displaying multimedia content, has a widget owner, corresponds to embeddable code, and is viewable on a site by the user. The method and system include receiving from the user a request for mixing the widget to provide the copy. The copy is a customized copy of the widget. The method and system also include receiving at least one change to the widget as viewed by the user and storing the at least one change in a memory and separate from the embeddable code. The customized copy is renderable based on the embeddable code and the at least one change.

### CROSS-REFERENCE TO RELATED APPLICATIONS

This application claims the benefit of provisional Patent Application Ser. No. 61/085,231, filed Jul. 31, 2008, assigned to the assignee of the present application, and incorporated herein by reference.

### BACKGROUND

The World Wide Web has matured into an integral part of daily life for users around the world. The Internet may be used for commerce, social transactions, sharing of multimedia content, and other activities. In order to display media for such activities, conventional widgets may be used. For example, a user may load a page, or site, containing the conventional widget and view content, such as video, provided by the conventional widget. Conventional widgets are generally embeddable, portable applications that often run without access to a user's file system. The conventional widget may be copyable by users. Thus, a user may copy a widget from a site to a location of the user's choosing, for example the user's own blog. Conventional widgets are also generally small in size and less complex than typical applications, such as email or word processing applications. However, there is typically no agreed upon limitation in size or complexity for conventional widgets. Such widgets may be used, for example, by bloggers to share their views, playlists, video, or other content that is of interest to them. More recently, widgets may be used for other purposes, such as advertising or other functions.

Furthermore, users may be allowed to duplicate widgets accessed on another site. For example, a widget owner may configure a widget based on a template provided by a provider. The widget owner then publishes the widget to a site. A user viewing the widget may return to the site at which the widget was built and access a template used to build the widget. The user may then duplicate the widget by adding the same multimedia or other content to his/her own widget. Stated differently, the user may be allowed to rebuild the widget, then publish it as his/her own. The user may also be allowed to further customize the widget. For example, the user may be allowed to add additional content or remove some of the content displayed on the widget. Thus, a user may be able to obtain a customized version of another widget. Alternatively, the widget might contain a copy field that allows a user to copy the widget as viewed on the site, without further customization.

Although widgets are useful, their ability to readily reflect individual users' tastes may be limited. Consequently, users' ability to engage in social, commercial, and other transactions including sharing of multimedia content may be limited.

### BRIEF SUMMARY

The exemplary embodiment provides methods and systems for providing a copy of a widget. The widget is copyable, for dynamically displaying multimedia content, has a widget owner, corresponds to embeddable code, and is viewable on a site by the user. Aspects of exemplary embodiment include receiving from the user a request for mixing the widget to provide the copy. The copy is a customized copy of the widget. The method and system also include receiving at least one change to the widget as viewed by the user and storing the change(s) in a memory and separate from the embeddable code. The customized copy is renderable based on the embeddable code and change(s).

### BRIEF DESCRIPTION OF SEVERAL VIEWS OF THE DRAWINGS

FIG. 1 depicts an exemplary embodiment of a system for providing widgets.

FIG. 2 depicts an exemplary embodiment of a widget for dynamically displaying multimedia content.

FIG. 3 depicts an exemplary embodiment of a system for copying a widget.

FIG. 4 depicts an exemplary embodiment of a method for providing a copy of a widget.

FIG. 5 depicts another exemplary embodiment of a method for providing a copy of a widget.

### DETAILED DESCRIPTION

The exemplary embodiments relate to a method and system for providing customized copies of widgets. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

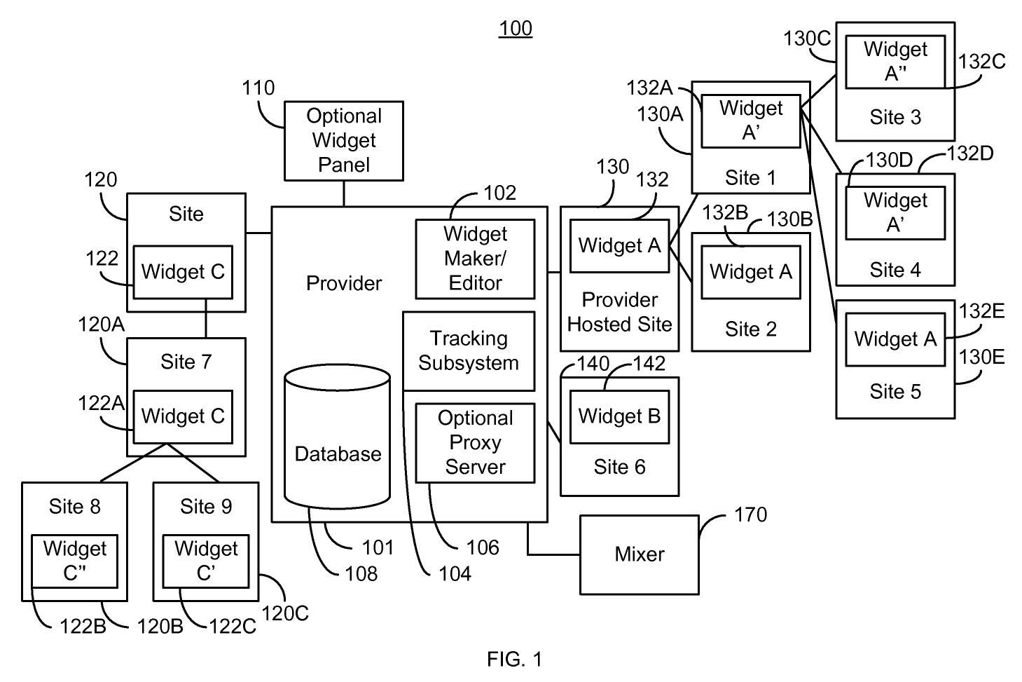

FIG. 1 depicts an exemplary embodiment of a system 100 for providing widgets. Although various portions of the system 100 are depicted in FIG. 1, other embodiments may include other, additional, and/or fewer components than the system 100. Similarly, in other embodiments, some of the functions performed by components of the system 100 may be separated into different components, combined into fewer components, or otherwise rearranged. The widgets provided via the system 100 may be used for various functions such as electronic commerce, social payment transactions (e.g. fundraising), affiliate marketing, advertisements, other social transaction such as sharing of multimedia, blogging, or other activities. The transactions and other activities may be performed through a variety of electronic media and platforms, for example via the Internet, through a cell network, using mobile phones, desktop computer systems, PDAs, laptop computer systems, or other electronic systems. Such transactions might, but need not, relate to events, such as advertising or other campaigns, personal events such as weddings, affiliate marketing, or other activities.

In the embodiment shown, the system 100 includes a provider 101. The provider 101 allows a widget owner to configure a widget, change a widget, and/or mix the widget. Mixing a widget includes copying a widget and customizing the copy. The customization may include changes made to the copy, thereby allowing the “copy” to differ from the widget. Thus, as used herein, a copy of a widget need not be identical to the original, ancestor widget. Instead, the copy is merely derived from the content already present in the ancestor widget. Further, mixing may be performed on copies of copies of widget(s). Thus, additional changes may be made to a widget that is a customized copy of another widget. The provider 101 may also host a widget, may enforce rules relating to the widget, may store data related to the widget owner, and perform other tasks related to the widget.

Coupled directly to the provider 101 are sites (e.g. blogs) 120, 130, and 140. The sites 120, 130, and 140 may correspond to the widget owner's own site, a provider hosted site, and/or other site(s). The widgets 122, 132, and 142 are provided on sites 120, 130, and 140, respectively. In addition, sites 120A, 120B, 120C, 130A, 130B, 130C, 130D, and 130E, are shown as indirectly coupled with the provider 101. The sites 120A, 120B, 120C, 130A, 130B, 130C, 130D, and include corresponding widgets 122A, 122B, 122C, 132A, 132B, 132C, 132D, and 132E, respectively. The coupling with the provider 101 of the sites 120, 130, 140, 150, 120A, 120B, 120C, 130A, 130B, 130C, 130D, 130E, 140A, 140B, 140C, and 140D indicates that the widgets 122A, 122B, 122C, 132A, 132B, 132C, 132D, and 132E, respectively, are child widgets rather than physical connections. For example, site 3 130C is not necessarily coupled to the provider 101 through the sites 130 and 130A. A child widget may be considered to be a mix or copy of another widget. For example, the widget 122A is a child of the widget 122. Thus, sites 120A, 120B, 120C, 130A, 130B, 130C, 130D, and 130E may receive content from and provide data to the provider 101 directly. In addition, for simplicity a single widget 122, 122A, 122B, 122C, 132, 132A, 132B, 132C, 132D, 132E, and 142 is shown as associated with each site 120, 130, 140, 120A, 120B, 120C, 130A, 130B, 130C, 130D, and 130E, respectively. However, in another embodiment, multiple widgets (not shown) may reside on a single site.

The provider 101 includes a widget maker 102 that may have a corresponding widget panel 110, tracking subsystem 104, optional proxy server 106, and a database 108. The provider 101 may also include the mixer 170. However, in other embodiments, the mixer 170 may reside elsewhere during use. For example, the mixer 170 might be a widget, and thus copyable and embeddable. Consequently, the mixer 170 is depicted as connected to the provider 101 rather than internal to the provider 101. The provider 101 might also provide other page(s) that are not shown for simplicity. Thus, the widget maker 102, tracking subsystem 104, widget panel 110, and database 108 may be controlled by and accessed through the provider 101. The mixer 170 may or may not be accessed through the provider's site and is thus shown as coupled to but not a part of the provider 101. The owner of the provider 101 may, for example, charge fees for use of and services provided in connection with the system 1 00. Although shown together at the provider 101, the components 102, 104, 106, 108, 110, and 110 may be remotely located and/or owned in whole or in part by another entity. In another embodiment, at least some of the components 102, 104, 106, 108, 110, and 110 might be omitted. Use of such components also depends upon the transactions for which the system 100 is utilized. In addition, although only one of each component 102, 104, 106, 108, and 110 are shown, multiple versions may be provided. In an alternate embodiment, the tasks of the components 102, 104, 106, 108, and 110 may also be divided in another manner.

The widget maker 102, as well as the widget panel 110 may be used to configure widgets 122, 132, 142, 122A, 122B, 122C, 132A, 132B, 132C, 132D, and 132E. In operation, the widget owner utilizes the widget maker 102 in order to generate and customize the widget 122, 132, and/or 142. In some embodiments, the widget maker 102 provides the widget panel 110, which is a user interface that allows the widget owner to provide input to the provider 101 to customize the widget 122, 132, and/or 142. In another embodiment, the widget owner's input may be provided in another manner. In some embodiments, the widget panel 110 is a page that provides one or more templates for the widget and allows the widget owner to select features of the widget 122, 132, and/or 142. For example, the color, shape, event(s)/campaign(s), photos and/or other images, music and/or other audio, or other externalities associated with the widget 122, 132, and/or 142, rich media, level of detail and other aspects of the widget 122, 132, and/or 142 may be set based on the widget owner's elections in the widget panel 110. The widget owner may also specify that the widget 122, 132, and/or 142 is to be associated with specific event(s), data sources, and/or content and may provide a profile for the type of events and/or content with which the widget 122, 132, and/or 142 may be associated. The widget owner may also specify the location of fields, data within the fields, colors, and other features of the widget 122, 132, and/or 142 through the widget maker 102. Thus, a single widget 122, 132, and/or 142 may be configured to display a variety of information in which the widget owner is interested. The widget maker/editor 102 provides code corresponding to the widget 122, which may then be executed. In one such embodiment, the executable code corresponding to the widget 122 may itself include changes made to a preexisting template when the widget 122 is customized.

In some embodiments, the widget maker 102 and optionally the widget panel 110 may also be used for the customizing the child widgets 122A, 122B, 132A, 132B, 132C, 132D and/or 132E. However, in general, the mixer 170 is used. A child widget is a widget that is formed based on another widget. As discussed above, the widgets, such as the widgets 122, 132, and/or 142, may be provided with a “mix” button (not shown in FIG. 1). Upon selection of the mix button, a user may be returned to a site corresponding to the provider 101 that includes the mixer 170. Alternatively, the user may be otherwise directed to the mixer 170. For example, the mixer 170 may be a widget that may be provided to the user's machine in response to selection of the “mix” button. In other embodiments, the child widgets may be customized using the widget maker 102. For example, the optional widget panel 104 might be accessed in response to the mix button in the widget 122 or 132 being clicked or an analogous action being taken. The code for the widget 122 or 132 may then be loaded into the widget panel 104. For example, the widget 122 may correspond to a structured document language code. In such an embodiment, clicking of the mix button may not only bring up the provider's site but also the code for the widget 122. In other embodiments, the code for the widget 122 as it exists on the site and the default template from which the widget 122 is formed are offered as options for customization. In some embodiments, the code for the widget 122 includes the default template upon which the widget 122 is based and a file indicating changes to the default template made for the widget 122. Thus, the executable code for the widget 122 may include changes made to the template. The user may then be allowed build the new child widget by further customizing the widget 122 or leaving the widget 122 unchanged. In some embodiments, the code for the new child widget 122B/132A is determined based upon the default template or embeddable code for the parent widget 122/132 and a file indicating changes made to the default template or embeddable code to obtain the new child widget 122B/132A. The user may then be allowed to publish their own widget, such as the widget 122B or 132A on the desired site 120B or 130A.

The tracking subsystem 104 may be used to track various attributes of the widgets 122, 132, and 142 and, in some embodiments, the child widgets such as the widgets 122A, 122B, 122C, 132A, 123B, 132C, 132D, and 132E. The tracking subsystem 104 tracks creation of a parent widget. In some embodiments, this includes generating a file indicating changes to a provided default template (which may be blank) made in customizing the parent widget. Further, subsequent changes to the parent widget are also tracked. For a child widget, the tracking subsystem 104 may record any changes made to the parent widget when customizing the child widget. These may be stored in the form of a change file. Other activities associated with the widgets may also be tracked by the tracking subsystem 104. For example, click throughs, number of times viewed, copies, or other ongoing attributes related to the widget may be tracked using the tracking subsystem 104. The tracking subsystem 104 may authenticate users, widgets, and/or the widget characteristics. The tracking subsystem 104 may also track differences between parent and child widgets. For example, the widget 122A is a child of the widget 122. The differences between the widget 122A and the widget 122 may be tracked using the tracking subsystem 104. The changes tracked using the tracking subsystem 104, as well as other information related to the widgets 122, 132, 142, 122A, 122B, 122C, 132A, 132B, 132C, 132D and/or 132E, such as widget identifications and code, may be stored in the database 108.

The optional proxy server 106 may be used to replicate the widget(s) to other sites. Furthermore, in some embodiments, the proxy server 106 may allow content, such as rich media audio or video, from site(s) not directly associated with the provider 101 to be played on the widgets. In some embodiments, widgets may communicate directly through the proxy server 101, for example to disseminate comments, donation amounts, and/or other information. In other embodiments, the proxy server 106 may be omitted.

The database 108, or storage, may store data relating to the widget owner and the widgets hosted by the provider 101. For clarity the database 108 is described in the context of the widget 122. Thus, the database 108 may store the parameters and other data corresponding to the widget owner's selections for the widget 122, the identities of each widget and widget owner, as well as other data related to the widget owner. The changes to a widget made in forming a customized copy of the widget may also be stored in the database 108. Thus, the widget data may be considered to include owner selected widget features, payment features (if any), and event features (if any). For example, widget features may include the content such as rich media displayed on the widget, colors, specific content providers authorized to host the widget, profiles of content providers authorized to host the widget, parameters related to updating the widget, and other data used in customizing the widget. The widget owner, owner of the widget maker 102, the provider 101, and/or another authorized entity may also specify parameters corresponding to the ability of the widget 122 and/or the children of the widget 122 to be customized. These parameters may also be stored in the database 108. Also stored in the database 108 may be relationships between widgets. For example, the database 108 may store the identity of the widgets 122, 122A, 122B, and 122C as well as indications that 122A is a copy of 122, and that 122B and 122C are copies of 122A. In some embodiments, the indication of the relationship between the widgets 122, 122A, 122B, and 122C is stored in the change file, described below, generated when the copies 122A, 122B, and 122C are customized. In addition, the database 104 may store information from the tracking subsystem 104. For example, the changes made when going from a parent to a child widget may be separately stored in the database 108 or other location. Although not separately shown, the provider 101 may include other components. For example, the provider 101 may include server(s) for rendering, authenticating, and performing other functions related to the widgets 122, 132,142, 122A, 122B, 122C, 132A, 132B, 132C, 132D, and/or 132E.

Among other functions, the system 100 may be used to facilitate customization of widgets. For clarity, the widgets 132, 132A, 132B, and 132C are described. However, the discussion herein may apply to all widgets 122, 122A, 122B, 122C, 132, 132A, 132B, 132C, 132D, 132E, and 142. Widgets such as the widget 130 may be built and then published on sites, such as the site 130. In some embodiments, the widget 132 may include a mix button. In other embodiments, the widget 132 may simply include a copy button through which customizations of the copy 132A or 132B may be made. However, such a copy button, when included with a mix button, would generally be used only for identical copies. Users viewing the widgets 132, 132A, and 132B on the sites 130,130A and 130B may desire copies of some or all of the widgets. By clicking on the “mix” button, or performing some simple analogous task, a user may be redirected to the mixer 170 or the widget maker 102. A user may use the widget maker 102 to initially configure the widget 132, which is then posted on the owner's site 130. When another user desires to copy or mix the widget 132, the widget maker 102 or mixer 170 provides to the users the widgets such as the widget 132 as configured for the sites 130. The users may thus have access to the widget 130 as viewed on the sites. The user may also be allowed to further customize their version 132A or 132B of the widget 130 already customized and available on the site 130. For example, the user may be allowed to add additional multimedia content, exchange multimedia content, or delete multimedia content. In one embodiment, the changes to the widget 132 are stored separately in a memory, such as the database 108. For example, the mixer 170 may generate a change file indicating the difference between the widget 132A and the widget 132. This file may be stored by the provider 101 on the database 108. The change file may also be part of the executable code forming the widget 132A. The changes may also be stored on the user's machine on which the site 130A or 130B may be viewed. In such an embodiment, the change file stored on the user's machine may take the form of a browser-based cookie. Similarly, the change file may be stored using a cookie-like mechanism such as a Flash shared object. Alternatively, the changes may be stored in a change file on the database 108 or the user's machine. Note that the customization allowed may be restricted, for example by the original owner of the widget 130. The user may then be allowed to publish the customized widget 132A or 132B on a desired site 130A or 130B, respectively. As a result, the user may more quickly and easily configure their desired widget 132A or 132B. In some embodiments, moderation is employed. Thus, the widgets 132A or 132B may require approval or a lack of disapproval to be published on or remain published on the desired sites. Further, the original owners of the original, ancestor widget 132 may restrict the manner in which their widgets 132 are further customized. Conditional logic may also be employed to allow the widget 132A, 132B, 132C to change in response to the fulfilling of particular conditions. This process of allowing customized copies to be made of widgets may continue to other widgets. For example, a user may make a customized copy 132C of the widget 132A. In such a case, the mixer 170 may generate a new change file. In one embodiment, this change file includes only the differences between the widget 132A and 132C. In such an embodiment, the change file for the changes between the widgets 132 and 132A and the change file describing the changes between the widgets 132A and 132C are both used in addition to the embedded code for the widget 132 in rendering the copy 132C. In another embodiment, a single change file indicates the changes between the widget 132C and the widget 132. In such an embodiment, the embedded code for the widget 132 and the change file for the differences between the widget 132 and the widget 132C are used in rendering the widget 132C. Consequently, ease of customization may be improved while allowing the original widget owners to maintain at least some degree of control over the mixed widgets.

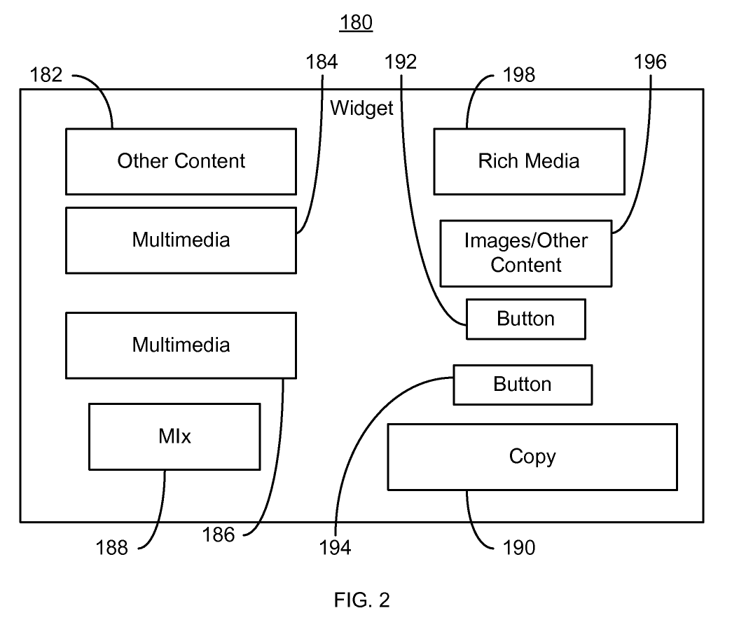

FIG. 2 depicts an exemplary embodiment of a widget 180 that may dynamically display multimedia content. The widget is viewable by a user, copyable by individuals other than the widget owner, for dynamically displaying multimedia content, and corresponds to embeddable code. In some embodiments, the user viewing the widget is also the owner. The widget 180 may thus correspond to one or more of the widgets 122, 132, 142, 122A, 122B, 122C, 132A, 132B, 132C, 132D, and 132E depicted in FIG. 1. Thus, the designations 180 and 122, 132, 142, 122A, 122B, 122C, 132A, 132B, 132C, 132D, and/or 132E may be used interchangeably herein. Referring to FIGS. 1 and 2, the widget 180 includes fields 182, 184, 186, 188, 190, 192, 194, 196, and 198. The widget 180 may also include other information (not shown in FIG. 2) such as the header. The widgets 122, 132, 142, 122A, 122B, 122C, 132A, 132B, 132C, 132D, and 132E may include some or all of these fields 182, 184, 186, 188, 190, 192, 194, 196, and 198 as well as other fields (not shown). Moreover, although only one of each field 182, 184, 186, 188, 190, 192, 194, 196, and 198 are shown, multiple versions of one or more of the fields 182, 184, 186, 188, 190, 192, 194, 196, and 198 might be included. For example, multiple rich media fields 198, multiple images/content fields 196 and multiple fields 182 for tracking an event associated with a widget may be included. In addition to the fields 182, 184, 186, 188, 190, 192, 194, 196, and 198, the color and other aspects of the widget 180 may be customized. Configuration of the fields 182, 184, 186, 188, 190, 192 194, 196, and 198 may thus be part of customization of the widget 180. For example, the inclusion of, size, and placement of the fields 182, 184, 186, 188, 190, 192, 194, 196, and 198 may differ between the widgets 122, 132, 142, 152, 122A, 122B, 122C, 132A, 132B, 132C, 132D, 132E, 142A, 142B, 142C, and 142D.

The fields 182, 184, 186, 192, 194, 196, and 198 may be used for various purposes depending upon the purpose for which the widget 180 is desired. For example, they may include multimedia such as images or other content, rich media, video, and other items. Consequently, the fields 182, 184, 186, 192, 194, 196, and 198 may include images, video, audio, or other content. The field 190 is a copy field. Through this field, a user may obtain an uncustomizable copy of the widget 180. In contrast, the field 188 is a mix field. In one embodiment, the field 188 corresponds to a button. As described above, a user viewing the widget 180 may utilize the mix field 188 to more easily obtain a child widget of the widget 180.

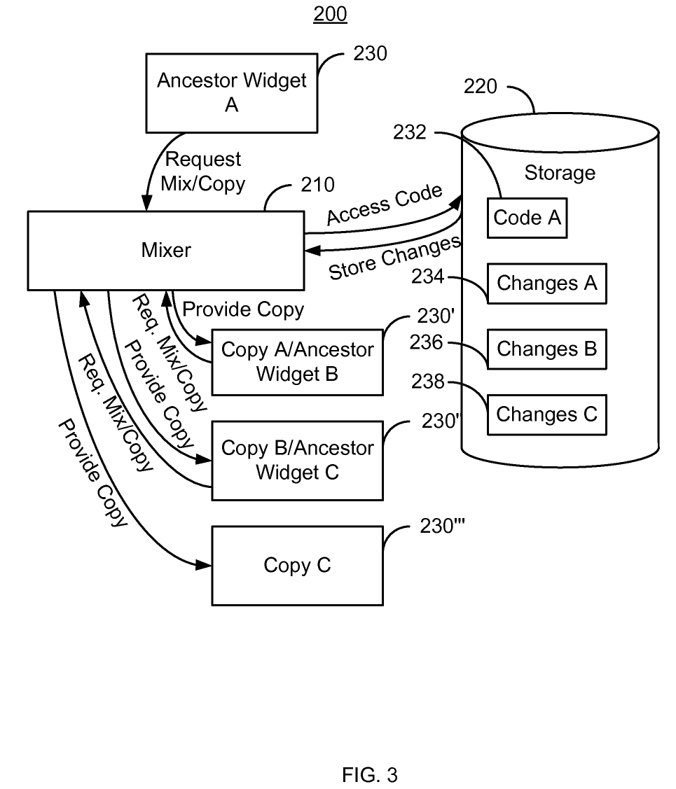

FIG. 3 depicts an exemplary embodiment of a system 200 for copying a widget. For simplicity, only some components of the system 200 are shown. The system 200 is analogous to portions of the system 100. The system 200 includes a mixer 210 and storage 220. Although shown as a single storage 220, the storage 220 may include multiple memories in different locations. Also shown are widgets 230, 230′, 230″, and 230′″, which are used to describe particular functions of the system 200. Although the system 200 is described in terms of the widgets 230, 230′, 230″, and 230″, the system 200 may be used with multiple ancestor widgets and copies. Ancestor widget A 200 is analogous to one or more of the widgets 122, 132, 142, 122A, 122B, 122C, 132A, 132B, 132C, 132D, 132E, and 180 depicted in FIGS. 1 and 2. The ancestor widget A 210 is thus viewable by a user, copyable by individuals other than the ancestor widget A owner, for dynamically displaying multimedia content, and corresponds to embeddable code 232, for example an XML applet. In some embodiments, the executable code for the ancestor widget A 230 itself includes a changelist indicating the changes made to configure the original ancestor widget A 230. The ancestor widget A 230 may also be compatible with multiple platforms. In some embodiments, the user viewing the widget 230 is also the owner. In other embodiments, a user of the system 200 may be any individual viewing and desiring to copy a widget. In one embodiment, the ancestor widget A 230 is configured using a widget maker, such as the widget maker 102. The ancestor widget A 230 may be viewable on a site (not explicitly shown) by users other than ancestor widget A owner. The embeddable code for ancestor widget A 230 may be stored in the database 220.

The mixer 210 is used in forming customized copies of widgets, such as ancestor widget A 230. The copies may be made by users that are not owners of the ancestor widget A 230. The mixer 210 is thus configured to receive and store changes to pre-existing embeddable code 232 such that the changes and embeddable code 232 may be used to render and use the new, customized copy of the ancestor widget A 230. The mixer 210 thus has access to the storage 220 that includes the embeddable code 232 for the ancestor widget A 230. In operation, the mixer 210 functions in an analogous manner to the widget maker 102. However, the mixer 210 may have a subset of functions of the widget maker 102. The mixer 210 may be desired to have reduced functionality in order to simplify customization of copies by a user. For example, the user may be constrained in the changes made to a copy of a particular widget. However, in other embodiments, the mixer 210 may have substantially the same functionality as the widget maker 102. The mixer 210 may thus be an application that resides with a provider, such as the provider 101. In other embodiments, the mixer 210 may be a widget that is thus copyable, displays multimedia, has additional functionality related to storage of changes to the ancestor widget A 230, and corresponds to embeddable code that can be provided to the user.

More specifically, the mixer 210 receives input from a user indicating the user desires to identically copy the ancestor widget A 230 and/or make a customized copy of the ancestor widget A 230, which includes changes to the ancestor widget A 230. For example, the mixer 210 may receive a request for an identical copy/customized copy when the user selects the mix or copy button in a widget such as the widget 180. The mixer 210 may use a widget panel 110 or other feature to allow the user to customize the copy. In some embodiments, the mixer 210 may display the ancestor widget A 230 and allow the user to drag and drop other fields (not shown in FIG. 3) into the ancestor widget A 230, remove fields from ancestor widget A 230, change data sources for the ancestor widget A 230, change colors, ad additional functions such as updateable video, and/or make other customizations reflecting the user's preferences. The mixer 210 may also limit the options for customization provided to the user. For example, the mixer 210 may offer the user a specific set of choices for changes that may be made to the copy of the ancestor widget A 230. In other embodiments, the mixer 210 may receive the changes for the customized copy in another manner. Thus, the user has indicated the changes to ancestor widget A 230 desired for copy A 230′. Once entry of the changes is complete, the mixer 210 may generate a change file for the copy A 230′. The change file is shown as changes A 234 stored in storage 232. However, the changes A 234 may be stored in another format and/or at another location. For example, the changes A may be stored in on the user's machine as a browser-based cookie, while the embeddable code 232 may be in storage controlled by the provider 101 of the original ancestor widget A 230. Similarly, the change file may be stored using a cookie-like mechanism such as a Flash shared object. In some embodiments, the machine code corresponding to the copy A 230′ itself includes a changelist indicating the changes made to configure the original ancestor widget A 230. The embeddable code 232 and changes A 234 are configured such that the copy A 230′ may be rendered based on the embeddable code A 232 and the changes A 234, for example by a server (not shown in FIG. 3) or by the user's own machine (not shown in FIG. 3). Thus, the mixer 210 may be viewed as a mechanism for receiving changes to an existing widget and saving those changes such that a customized copy reflecting the existing widget plus the changes may be provided.

In operation, a user who may not be the owner of the ancestor widget A 230 and who may be viewing the ancestor widget A 230 may select mix or copy from the ancestor widget A 230, for example by clicking on the appropriate button. The user may thus request a mix/copy of the ancestor widget A 230. In response to this request, the user may be redirected to the mixer 210. The mixer 210 may access the code A 232 for the ancestor widget A 230 from the storage 220. The user may then input to the mixer 210 the desired changes to the ancestor widget A 230. For example, the user may add new multimedia content and/or data sources, delete a portion of the multimedia content displayed on the ancestor widget A 230, add functions, and/or change properties such as color and location of fields of the ancestor widget A 230. Stated differently, the user is allowed to customize their copy of the ancestor widget A 230. Note that in some embodiments, the user may be constrained in the changes they are allowed to make by the owner of the ancestor widget A. In one embodiment, the constraints may be provided in the form of parameters (not shown separately from code A 232 in FIG. 3)

Once the user has completed inputting the changes to the ancestor widget A 230, the mixer 210 stores the changes to provide the copy A 230′. The copy A 230′ is a copy of the ancestor widget A 230 but also includes any changes provided by the user which are not precluded by the owner of the ancestor widget A 230. Thus, the copy A 230′ is a customized copy of the ancestor widget A 230. In one embodiment, the mixer 210 stores the changes A 234 separately from the code A 232 such that the code A 232 for the ancestor widget A 230 and the changes A 234 can be used to render the customized copy A. Thus, the output of the mixer 210 may be considered to be the change file changes A 234. In the embodiment shown, the changes A 234 is stored in the same memory, or storage, as the code A 232 for the ancestor widget A 230. However, the changes A 234 may be stored elsewhere. For example, in one embodiment, the changes A 234 may be stored on the user's machine, for example as a browser-based cookie or cookie-like mechanism, or at another location. In some embodiments, the embeddable code 232 and changes A 234 are stored such that the copy A 230′ is compatible with multiple platforms. For example, the copy A 230′ may be compatible with various laptop/desktop browsers, cellular phones, iPods®, PDAs, or other devices. In some embodiments, the mixer 210 may also store an additional copy of the code A 232 related to the coy A 230′. However, in other embodiments, the same code A 232 for the ancestor widget A 230 is simply reused for the copy A 230′. Regardless of where the changes A 234 are stored, the changes A 234 in conjunction with the embeddable code A 232 may be used to render the copy A 230′.

The mixer 210 or analogous component may also be used to provide customized copies of copies, such as the copy A 230′. For example, a new user who may not be the owner of the copy A/ancestor widget B 230′ and who may be viewing the copy A/ancestor widget B 230′ may select mix or copy from the copy A/ancestor widget B 230′, for example by clicking on the appropriate button. Alternatively, the same user that owns the copy A/ancestor widget B 230′ may request the copy. Because it is being copied, the copy A 230′ is referred to as copy A/ancestor widget B 230′. The new user may thus request a mix/copy of the copy A/ancestor widget B 230′. In response to this request, the new user may be redirected to the mixer 210. The mixer 210 may access from the storage 220 the code A 232 for the ancestor widget A 230 as well as the changes 234 from the copy A/ancestor widget B 230′. The user may then input to the mixer 210 the desired changes to the copy A/ancestor widget B 230′, in an analogous manner to that described above. The new user is allowed to customize their copy of the copy A/ancestor widget B 230′ and thus ancestor widget A 230. Note that in some embodiments, the user may be constrained in the changes they are allowed to make by the owner of copy A/ancestor widget B 230′. In one embodiment, the constraints may be provided in the form of parameters (not shown separately from code A 232 and changes 234 in FIG. 3)

Once the new user has completed inputting the changes to the copy A/ancestor widget B 230′, the mixer 210 stores the changes to provide the copy B 230″. The copy B 230″ is a customized copy of the copy A/ancestor widget B 230′. The mixer thus stores the changes B 236. In one embodiment, the changes B 236 includes both the changes to ancestor widget A 230 made by the owner of the copy A/ancestor widget B 230′ and changes made to the copy A/ancestor widget B 230′. In such an embodiment, the code A 232 and changes B 236 are used in rendering the copy B 230″. In another embodiment, the changes B 236 includes only those changes made to the copy A/ancestor widget B 230′. In such an embodiment, the code A 232, changes A 234, and changes B 236 may all be used in rendering the copy B 230″. This process may similarly be followed for the copy C, which is a copy of the copy B/ancestor widget C 230″. The changes C 238 would also be stored and reflect the changes made to form the copy C 230′″.

Thus, using the system 200, customized copies of the ancestor widget A 230, copy A/ancestor widget B 230′, and copy B/ancestor widget C 230″ may be provided. Each of these customized copies 230′, 230″, and 230′″ corresponds to embeddable code, is copyable, may display multimedia and/or have other functions. A user may not only copy a widget 230 as viewed on a site, but also easily make changes to customize their copy. As a result, the desirability of the widgets 230, 230′, 230″, and 230′″ as well as the speed and ease with which they spread to other users and/or sites may be improved. Because the mixer 210 outputs the changes 234, 236, and 238 provided by the user(s), the mixer 210 may be relatively simple to build and provide to users. In addition, because the mixer 210 may be simpler and have more limited functions than the widget maker 102, the user(s) may more easily customize their copies. Further, the original code A 232 for the ancestor widget A 230 may used in rendering some or all of the customized copies 230′, 230″ and 230′″. Thus, any changes to the code A 232/ancestor widget A 230 made by the owner of the ancestor widget A 230 may be reflected in the copies 230′, 230″, and 230′″. For example, suppose the owner of the ancestor widget A 230 alters a field in the ancestor widget A 230. This change would be stored in the code A 232. The next time the copy B/ancestor widget C 230″ is rendered, the code A 232, changes A 234, and changes B may be used. When the code A 232 is rendered, these changes appear in the copy B/ancestor widget C 230″. Similarly, if the owner of copy A/ancestor widget B makes changes to the copy A/ancestor widget B 230′, these change may be stored in the changes A 234. The next time the copy B/ancestor widget C 230″ is rendered, the code A 232, changes A 234, and changes B may be used. The changes to the copy A/ancestor widget B 230′ are thus reflected in the copy B 230″. Thus, customized copies 230′, 230″, and/or 230′″ may be automatically updated with changes made to ancestor widget(s) 230, 230 and 230′; and 230, 230′, and 230″, respectively.

For example, suppose the ancestor widget A 230 is an advertisement widget. The advertisement may be relatively easily customized with colors, names, or other personal data and provided with additional function(s) to form copies 230′, 230″, and 230′″. If the changes 234, 236 and/or 238 are stored as a browser based cookie, then each time the user(s) see the ad, their customizations would appear in customized copies 230′, 230″, and 230′″ regardless of the site on which the user was viewing the copy 230′, 230″, and 230′″. Changes or updates to the ad made by the owner of the widget 230, for example a change in price or availability of the product, are stored in the code A 232. When the widgets 230′, 230″ and 230′″ are rendered using the code 232 and the appropriate change files 234, 236, and/or 238, these changes or updates may be automatically provided to the copies 230′, 230″, and 230′″.

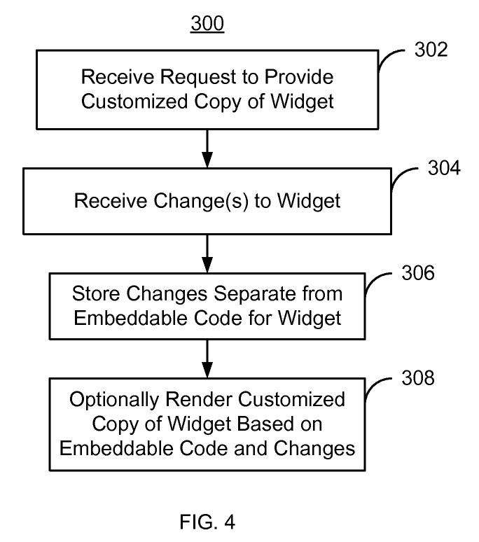

FIG. 4 depicts an exemplary embodiment of a method 300 for providing a copy of a widget. For clarity, the method 300 is described in the context of the system 200. More specifically, the method 300 is described in the context of the widgets 230 and 230′. However, the method 300 may be used with other widgets 230″, 230′″ and other (not shown). Although the method 300 is described as including particular steps, the method 300 may include other steps not inconsistent with the method and system. Further, certain steps of the method 300 might be combined. Although the method 300 is described in a particular sequence, in some embodiments certain steps may be performed in another order and at least partially in parallel.

A user is allowed to select the mix or copy feature from the ancestor widget A 230 that is currently being viewed, via step 302. In some embodiments, the widget is being viewed on a site, such as the site 130 or 130A. In other embodiments, the ancestor widget A 230 may be provided to the user and viewed in another manner. The ancestor widget A 230 may be a widget originally configured from a default or other template by a widget owner who may be different from and unrelated to the user. Alternatively, the widget ancestor widget A 230 may be a child of such a widget. The ancestor widget A 230 was thus previously customized or configured and rendered/published. In one embodiment, step 302 includes the user selecting the mix button 188 on the ancestor widget A 230. The user may also be directed to the mixer 210 or other analogous component. The mixer 210 may also be provided with a copy of code corresponding to the ancestor widget A 230. For example, the browser (not shown) of a user may be redirected to the mixer 210 and provided a widget panel, such as the widget panel 110, on the browser. The code 232 is reflected in the widget panel 210. The code corresponding to the ancestor widget A 230 may be the original embeddable code 232 plus and change files (not shown in FIG. 3) for the ancestor widget A 230 being copied. In one embodiment, the code provided for the ancestor widget A 230 being mixed/copied is one of the options the user is allowed to customize. For example, an ancestor widget A 230 or a template used by the widget owner to configure the ancestor widget A 230 might be offered as an option. In addition, if the method 300 is used to form the copy B 230″, then the code 232 for the ancestor widget A 230 and the changes for the copy A/ancestor widget B 230′ may be obtained. If the method 300 is used to form the copy C 230′″, then the code 232 for the ancestor widget A 230, the changes for the copy A/ancestor widget B 230′, the changes for the copy B/ancestor widget C 230″, and the changes for copy C 230′″ may be stored.

Changes to the ancestor widget A 230 that are desired for the copy are received, via step 304. In one embodiment, the mixer 210 receives the changes. The user is thus allowed to further customize the copy of the widget 230 using the mixer 210. In another embodiment, the widget maker 102 might be used. The user may add multimedia content, remove multimedia content, exchange one set of multimedia content for another, add functions, remove functions, change properties such as color, change data sources, or otherwise alter the ancestor widget A 230. As a result, the user may enter the desired changes that would result in the copy A/ancestor widget B 230′. Although the user is allowed to further customize the widget in step 304, the user may opt not to make any changes to the widget. Thus, the copy A/ancestor widget B 230′ may be an exact copy of the ancestor widget A 230 or may be modified.

The change(s) 234 provided by the user are stored, via step 306. Storage in step 306 is in a memory 220 and separate from the embeddable code 232 such that the customized copy (copy A/ancestor widget B 230″) is renderable based on the embeddable code 232 and the changes 234. Thus, step 306 may include the mixer 210 generating a change file (changes 234) that may be stored with the embeddable code 232 in storage 220 that is accessible to and controlled by the provider 101 of the original, ancestor widget A 230. In another embodiment, the mixer 210 may generate a change file, for example in the form of a browser-based cookie or other cookie-like mechanism, that is provided to the user's machine. The changes 234 may then be stored in memory on the user machine. Thus, the code corresponding to the copy of the ancestor widget A 230 (copy A/ancestor widget B 230′) is provided in two separate parts-the original code for the ancestor and the changes. If the method 300 is used to form the copy B 230″, then the code 232 for the ancestor widget A 230, the changes for the copy A/ancestor widget B 230′, and the changes 234 for ancestor widget B 230″ may be stored. In some embodiments, executable code, e.g. the widget itself, includes a changelist indicating the changes made to customize the widget. If the method 300 is used to form the copy C 230′″, then the code 232 for the ancestor widget A 230, the changes for the copy A/ancestor widget B 230′, and the changes for the copy B/ancestor widget C 230″ may be stored.

The copy A/ancestor widget B 230′ may be rendered based on the embeddable code 232 and changes 234, via step 308. For example, the user may publish the new (mixed) widget 230′ on the site desired by the user in step 308. Alternatively, the user may visit a site that hosts the ancestor widget A 230. Instead of the ancestor widget A 230 being displayed on the user's browser, the copy A/ancestor widget B 230′ may be displayed. Further, the widget and the customized copy are compatible with a plurality of platforms.

Using the method 300, the user is allowed to easily obtain the desired widget. In particular, the user need not start with a default and rebuild the desired widget. Instead, the user may start customization with the widget the user had found to be of interest. The ease with which the user may obtain the desired widget is thus improved. Further, the ease with which the ancestor widget A 230 and customized copies 230′, 230″, and 230′″ may be disseminated and adapted to their user's preferences may also be improved.

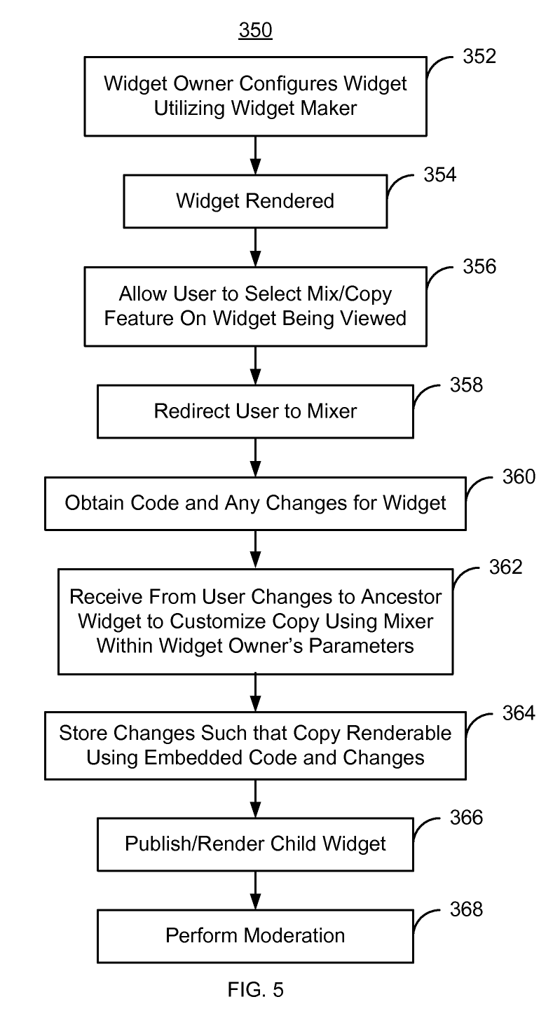

FIG. 5 depicts another exemplary embodiment of a method 350 for providing a widget. For clarity, the method 350 is described in the context of the system 200 and widget 180. More specifically, the method 350 is described in the context of the widgets 230 and 230′. However, the method 350 may be used with other widgets 230″, 230′″ and other (not shown). Although the method 350 is described as including particular steps, the method 350 may include other steps not inconsistent with the method and system. Further, certain steps of the method 350 might be combined. Although the method 350 is described in a particular sequence, in some embodiments certain steps may be performed in another order and at least partially in parallel.

A widget owner configures the ancestor widget A 230, via step 352. The embeddable code 232 for the ancestor widget A 230 is also generated based upon the configuration input by the user, via step 354. Steps 352 and 354 may be performed using the widget maker 102. In one embodiment, for example for the ancestor widget A 230, the widget owner actually builds the widget. To do so, the widget owner may utilize a template from the provider 101 or otherwise build the original ancestor widget A 230. In one such embodiment, an XML file is built in steps 352 and 354. In another embodiment, steps 352 and 354 may include copying another widget or mixing a widget, for example using the method 300. In such an embodiment, step 352 includes changing a pre-existing XML file or generating a change file as in the method 300. In such a case, the changes to the XML file or change file may be tracked by tracking subsystem 104 and saved, for example in a separate file on the database 108 or as part of the widget being customized.

The ancestor widget A 230 is rendered, via step 354. In one embodiment, the ancestor widget A 230 is published on a site in step 354. In one embodiment, XML is used to build the ancestor widget A 230. In such an embodiment, step 354 may include compiling the XML, obtaining a widget identification, and embedding the code 232 for the ancestor widget A 230 in the desired site. Thus, users are allowed to view and otherwise interact with the ancestor widget A 230 on the site.

A user is allowed to select the mix or copy feature from the ancestor widget A 230 that is currently being viewed, via step 356. Thus, a request for mixing the widget to provide the copy of the widget is received. The copy being provided is a customized copy of the widget. In some embodiments, the widget is being viewed on a site, such as the site 130 or 130A. In other embodiments, the ancestor widget A 230 may be provided to the user and viewed in another manner. In one embodiment, step 356 includes allowing a user to select the corresponding mix button 188. However, another analogous task could be performed by the user to indicate that a new widget is desired to be provided from the ancestor widget A 230 being viewed.

The user may also be redirected to the mixer 210 or other analogous component, via step 358. For example, the browser (not shown) of a user may be redirected to the mixer 210 and provided a widget panel, such as the widget panel 110, on the browser.

The code for the widget being mixed is accessed and provided to the mixer 210, via step 360. The code for the ancestor widget A 230 being copied/mixed is determined in step 360. In one embodiment, step 358 includes utilizing a widget identification for the ancestor widget A 230 to determine the XML file 232 and/or the file stored in the storage/database 220 indicating any. If a copy is being made of a copy, such as the widget 230′, 230″, or 230′″, then step 360 also includes determining and accessing any file(s) 234, 236, or 238 indicating change(s) made to the widget 230′, 230″, or 230′″ in the storage 220. The appropriate XML file(s) corresponding to the widget being copied is thus determined. In one embodiment, the code provided for the ancestor widget A 230 being mixed/copied is one of the options the user is allowed to customize, as described above. Thus, the appropriate XML file or corresponding file 232 for the widget being viewed by the user is provided to the mixer 210. In one embodiment, other code may also be provided to the mixer 210. For example, defaults normally made available by the provider 101 may also be made available to the widget maker 102.

The mixer receives change(s) to the widget as viewed by the user, via step 362. The user is thus allowed to further customize the copy of the ancestor widget A 230 using the mixer 210. The user may add multimedia content, remove multimedia content, exchange one set of multimedia content for another, add functions, remove functions, change properties such as color, change data sources, or otherwise alter the ancestor widget A 230. As a result, the user may enter the desired changes that would result in the copy A/ancestor widget B 230′. Although the user is allowed to further customize the widget in step 362, the user might opt not to make any changes to the widget. Thus, the copy A/ancestor widget B 230′ may be an exact copy of the ancestor widget A 230 or may be modified.

In one embodiment, the ability of the user to customize the widget in step 262 may be limited. For example, although changes might be received in step 362, they may not be accepted. In another embodiment, the changes allowed may be constrained. In particular, the owner of the ancestor widget A 230, the provider 101, the owner of the mixer 210 and/or another authorized entity may have constrained the changes that may be made to children of the ancestor widget A 230. For example, the sources of multimedia content, the type of content, the sites on which children of the ancestor widget A 230 may reside or other aspects of the child widget may be constrained. In general, these constraints are determined when the owner builds the widget in step 352, but may be updated throughout the lifetime of the ancestor widget A 230. Thus, through step 362, the user is able to configure the copy A/ancestor widget B 230′ from the ancestor widget A 230. Similarly, the widgets 230″ and 230′″ may be configured from the widgets 230′ and 230″, respectively.

In addition, conditional logic might be provided in the ancestor widget A 230 and thus the copy A/ancestor widget B 230′. Such conditional logic might also be added in step 362. The conditional logic may cause the widget copy A/ancestor widget B 230′ to perform certain functions based on the fulfillment of certain conditions. For example, upon expiration of a particular time, the widget 230, 230′, 230″, and/or 230′″ might cease to function, change its look, gain access to other multimedia, or perform other functions.

The change(s) 234 provided by the user are stored, via step 364. Storage in step 364 is in a memory 220 and separate from the embeddable code 232 such that the customized copy (copy A/ancestor widget B 230″) is renderable based on the embeddable code 232 and the changes 234. Thus, step 364 may include the mixer 210 generating a change file (changes 234) that may be stored with or as part of the embeddable code 232 in storage 220 that is accessible to and controlled by the provider 101 of the original, ancestor widget A 230. In another embodiment, the mixer 210 may generate a change file, for example in the form of a browser-based cookie or other similar mechanism, that is provided to the user's machine. The changes 234 may then be stored in memory on the user machine. Thus, the code corresponding to the copy of the ancestor widget A 230 (copy A/ancestor widget B 230′) may be provided in separate files. If the method 350 is used to form the copy B 230″, then the code 232 for the ancestor widget A 230, the changes for the copy A/ancestor widget B 230′, and the changes 234 for ancestor widget B 230″ may be stored. If the method 350 is used to form the copy C 230′″, then the code 232 for the ancestor widget A 230, the changes for the copy A/ancestor widget B 230′, and the changes for the copy B/ancestor widget C 230″ may be stored.

The copy A/ancestor widget B 230′ may be rendered based on the embeddable code 232 and changes 234, via step 366. For example, the user may publish the new (mixed) widget 230′ on the site desired by the user in step 366. Alternatively, the user may visit a site that hosts the ancestor widget A 230. Instead of the ancestor widget A 230 being displayed on the user's browser, the copy A/ancestor widget B 230′ may be displayed. The method of claim 1 wherein the widget and the customized copy are compatible with a plurality of platforms. In one embodiment, step 366 includes providing an executable file from the XML files 232 and 234. In addition, the tracking subsystem 104 may also be used to determine changes made to the XML file of the ancestor widget A 230. Thus, the copy A/ancestor widget B 230′ may be made available or otherwise used desired by the user.

Moderation may also be performed, via step 368. Moderation provides an additional opportunity for the owner of the ancestor widget A 230, the provider 101, the owner of the mixer 210 and/or another authorized entity for the ancestor widget A 230 to control dissemination of the copy 230′, as well as copies 230″ and 230′″. Similarly, the owner of the copy A/ancestor widget B 230′ may control dissemination of the copies 230″ and 230″. The owner of copy B/ancestor widget C 230″ may also control dissemination of the copy C 230′″. In one embodiment, for example, the copy A/ancestor widget B 230′ may be published on the desired site or otherwise used by its owner unless and until the widget owner of the ancestor widget A 230, the provider 101, the owner of the mixer 210 and/or another authorized entity for the ancestor widget A 230 disapproves the widget 230′. In another embodiment, the copy A/ancestor widget B 230′ is not allowed to be published or used unless and until the widget owner for the ancestor widget A 230, the provider 101, the owner of the mixer 210 and/or another authorized entity for the ancestor widget A 230 approves the widget 230′. Similar moderation might be performed for the widgets 230″ and 230′″.

Using the method 350, child widgets, such as the widgets 230′, 230″, and/or 230′″ may be more easily customized. In particular, a user viewing a widget, such as the ancestor widget A 230 on a may admire the look of the ancestor widget A 230. Using the method 300 and/or 350 the user may more easily obtain a customized copy of the ancestor widget A 230, further customize the copy, and publish and/or use the customized child widget, such as the widget 230′. This process may be continued for other copies 230″ and 230′″. Thus, the ability of the user to quickly and easily obtain a desired widget based on another widget is improved.

A method and system for copying and customizing a widget has been disclosed. The method and system has been described in accordance with the embodiments shown, there could be variations to the embodiments, and any variations would be within the spirit and scope of the present invention. For example, the exemplary embodiment can be implemented using hardware, software, a computer readable medium containing program instructions, or a combination thereof. Software written according to the present invention is to be either stored in some form of computer-readable medium such as a memory, a hard disk, or a CD/DVD-ROM and is to be executed by a processor. Accordingly, many modifications may be made by one of ordinary skill in the art without departing from the spirit and scope of the appended claims.

We claim:

1. A computer-implemented method for providing a copy of a widget for a user, the widget being copyable, for dynamically displaying multimedia content, having a widget owner, corresponding to embeddable code, and being viewable on a site by the user, the method comprising:
receiving from the user a request for mixing the widget to provide the copy of the widget, the copy being a customized copy of the widget;
receiving at least one change to the widget as viewed by the user;
storing the at least one change in a memory and separate from the embeddable code, the customized copy being renderable based on the embeddable code and the at least one change.

2. The method of claim 1 further comprising:
rendering the customized copy based on the embeddable code and the at least one change.

3. The method of claim 1 wherein the user views the customized copy on a user machine and wherein the step of storing the at least one change further includes:
storing the at least one change on the user machine.

4. The method of claim 3 wherein the at least one change is stored as a cookie on the user machine.

5. The method of claim 1 wherein the step of storing the at least one change further includes:
storing the at least one change in a change list with a provider, the provider also storing the embeddable code.

6. The method of claim 1 further comprising:
referring the user a mixer in response to receiving the request, the mixer for receiving the at least one change and generating a change list indicating the at least one change.

7. The method of claim 6 wherein the mixer includes an additional widget.

8. The method of claim 1 wherein the at least one change includes at least one of adding additional multimedia content, deleting a portion of the multimedia content, adding a function, and changing a property of the widget.

9. The method of claim 1 wherein the widget and the customized copy are compatible with a plurality of platforms.

10. The method of claim 1 further comprising:
receiving input the widget owner to configure the widget;
generating the embeddable code based upon the input; and
rendering the widget on the site.

11. The method of claim 1 further comprising:
generating executable code for the widget including the at least one change and the embeddable code.

12. A computer-implemented method for providing a copy of a widget for a user, the widget being copyable, for dynamically displaying multimedia content, having a widget owner, corresponding to embeddable code, and being viewable on a site by the user, the method comprising:
receiving from the user a request for mixing the widget to provide the copy of the widget, the copy being a customized copy of the widget;
referring the user to a mixer in response to receiving the request, the mixer capable of being a widget;
receiving by the mixer at least one change to the widget as viewed by the user, the at least one change include at least one of adding additional multimedia content, deleting a portion of the multimedia content, adding a function, and changing a property of the widget;
storing the at least one change in a memory and separate from the embeddable code, the customized copy being renderable based on the embeddable code and the at least one change,

13. A system for providing a copy of a widget for a user, the widget being copyable, for dynamically displaying multimedia content, having a widget owner, corresponding to embeddable code, and being viewable by the user, the system being stored on a computer-readable medium and comprising;
a mixer for receiving at least one change to the widget from the user and storing the at least one change in a memory and separate from the embeddable code, the copy being a customized copy and corresponding to the widget and the at least one change;
wherein the customized copy is rendered based on the embeddable code and the at least one change.

14. The system of claim 13 wherein the widget further includes a mixer button for requesting the at least one change.

15. The system of claim 13 further comprising:
at least one server for rendering the customized copy based on the embeddable code and the at least one change.

16. The system of claim 13 wherein the user views the customized copy on a user machine and wherein the mixer further stores the at least one change as a change file on the user machine

17. The system of claim 13 wherein the user views the customized copy on a user machine and wherein the mixer further stores the at least one change as a cookie on the user machine

18. The system of claim 13 wherein the mixer is an additional widget.

19. The system of claim 13 further comprising:
a widget maker for receiving input from the widget owner to configure the widget and for generating the embeddable code based upon the input

20. The system of claim 13 wherein the mixer further generates executable code for the widget including the at least one change and the embeddable code.

21. A widget comprising:
embeddable code for an ancestor of the widget, the ancestor widget being copyable, for dynamically displaying multimedia content, having an ancestor widget owner, and being viewable on a site by the user, the widget being a customized copy of the ancestor widget, the widget for displaying at least a portion of the multimedia content and being owned by a user different from the ancestor widget owner; and
a change file including at least one change to the ancestor widget, the widget being a customized copy of the ancestor widget renderable based on the embeddable code and the change file.

22. The widget of claim 21 wherein the user views the widget on a user machine and wherein the at least one change file includes a cookie stored on the user machine.

23. The widget of claim 21 wherein the widget and the ancestor widget are compatible with a plurality of platforms.

24. An executable software product stored on a computer-readable medium containing program instructions for providing a copy of a widget for a user, the widget being copyable, for dynamically displaying multimedia content, having a widget owner, corresponding to embeddable code, and being viewable on a site by the user, the program instructions for:
receiving from the user a request for mixing the widget to provide the copy of the widget, the copy being a customized copy of the widget;
receiving at least one change to the widget as viewed by the user;
storing the at least one change in a memory and separate from the embeddable code, the customized copy being renderable based on the embeddable code and the at least one change.

25. The executable software product of claim 24 wherein the instructions further include:
rendering the customized copy based on the embeddable code and the at least one change.

26. The executable software product of claim 24 wherein the user views the customized copy on a user machine and wherein the instructions for storing the at least one change further includes:
storing the at least one change on the user machine.

27. The executable software product of claim 26 wherein the at least one change is stored as a cookie on the user machine.

28. The executable software product of claim 24 wherein the instructions for storing the at least one change further include:
storing the at least one change in a change list with a provider, the provider also storing the embeddable code.

29. The executable software product of claim 24 wherein the instructions further include:
referring the user a mixer in response to receiving the request, the mixer for receiving the at least one change and generating a change list indicating the at least one change.

30. The executable software product of claim 29 wherein the mixer includes an additional widget.

31. The executable software product of claim 24 wherein the widget and the customized copy are compatible with a plurality of platforms.
